(19) United States
(12) Patent Application Publication
(10) Pub. No.: US 2020/0326204 A1
(43) Pub. Date: Oct. 15, 2020

(54) DISPLAY DEVICE, DISPLAY SYSTEM COMPRISING SUCH A DEVICE, RELATED DISPLAY METHOD AND COMPUTER PROGRAM

(71) Applicant: THALES, Courbevoie (FR)

(72) Inventors: Maxime DECHATRE, Merignac (FR); Emmanuel Humbert, Merignac (FR); Maxime Caillaud, Merignac (FR); Yannick Le Roux, Merignac (FR)

(21) Appl. No.: 16/844,724

(22) Filed: Apr. 9, 2020

(30) Foreign Application Priority Data
Apr. 15, 2019 (FR) 19 03990

(51) Int. Cl. G01C 23/00; G06F 3/041; G08G 5/00; B64D 43/00

(52) U.S. Cl. CPC G01C 23/00; B64D 43/00; G08G 5/0021; G06F 3/0412

(57) ABSTRACT

The invention relates to an electronic device for displaying data on a display screen. The display device is able to be connected to a first interaction member, configured to select a first setpoint of a parameter from a first set of possible values, a second interaction member configured to select a second setpoint of said parameter from a second set of possible values, and the display screen.

The display device comprises an obtaining module configured to obtain a value of a setpoint among the first setpoint and the second setpoint and a generating module configured to generate display data as a function of a resultant setpoint value.

The display device comprises a determining module configured, after obtaining at least one value of the second setpoint, to determine a recalibrated resultant setpoint value as a function of a value of the first set.

### CROSS-REFERENCE TO RELATED APPLICATIONS

This application is a U.S. non-provisional application claiming the benefit of French Application No. 19 03990, filed on Apr. 15, 2019, which is incorporated herein by reference in its entirety.

### FIELD

The present invention relates to a device for displaying data on a display screen, the display device being able to be linked to a first interaction member, a second interaction member and a display screen.

The invention also relates to a data display system, in particular configured to be embedded on an aircraft, comprising a display screen, a first interaction member, a second interaction member and such a display device linked to the first interaction member, the second interaction member and the display screen.

The invention also relates to a method for displaying data on a display screen, the method being implemented by an electronic display device able to be linked to a first interaction member, a second interaction member and a display screen.

The invention also relates to a non-transitory computer-readable medium including a computer program including software instructions which, when executed by a computer, implement such a display method.

The invention relates to the field of data display systems, preferably suitable for being embedded in an aircraft, in particular in an aircraft cockpit.

The invention in particular relates to the field of display devices included in these data display systems, in particular screens associated with various interaction members.

### BACKGROUND

A display device of the aforementioned type is then known, including an obtainment module configured to obtain a value of the setpoint among a first setpoint by a first interaction member and a second setpoint by a second interaction member, and to generate display data as a function of a resultant setpoint value, the resultant setpoint value being the sum of an initial setpoint value and the obtained setpoint value.

However, such a device is not fully satisfactory.

### SUMMARY

The aim of the invention is then to propose a display device making it possible, in the case where a first interaction member is configured to define a value of a setpoint of a parameter among a first set of possible values, and a second interaction member is configured to define a value of a setpoint of the same parameter among a second set of possible values, the second set of values including the first set of values, to offer better coherence between the setpoint values obtained by these two interaction members.

To that end, the invention relates to a device for displaying data on a display screen, the display device being able to be linked to a first interaction member, a second interaction member and the display screen, the display device comprising:

an obtaining module configured to obtain a value of a setpoint among the first setpoint from the first interaction member and the second setpoint from the second interaction member, and

a generating module configured to generate display data as a function of a resultant setpoint value, the resultant setpoint value being the sum of an initial setpoint value and the obtained setpoint value;

the display device further comprises a determining module configured, after obtaining at least one value of the second setpoint, to determine a resultant setpoint value recalibrated from the last resultant setpoint value used, the recalibrated resultant setpoint value being a function of a value of the first set, the initial setpoint value used during the next display data generation being the recalibrated resultant setpoint value, the display parameter of the data being a zoom or a resolution with which the data can be displayed on the display screen.

According to other advantageous aspects of the invention, the display device comprises one or more of the following features, considered alone or according to all technically possible combinations:

the recalibrated resultant setpoint value is the sum of the initial setpoint value and the last value of the first set corresponding to a value of the second setpoint;

the recalibrated resultant setpoint value is the sum of the initial setpoint value and a first setpoint value that is closest to the last used value of the resultant setpoint value;

the determining module is configured in order, after obtaining only first setpoint value(s), to determine the sum of the last used first setpoint value and the initial setpoint value as initial setpoint value during the next display data generation;

the device further comprises a display module configured to display, on the display screen, the generated display data.

The invention also relates to a data display system, in particular configured to be embedded on an aircraft, comprising a display screen, a first interaction member, a second interaction member and a display device, the display device being linked to the first interaction member, the second interaction member and the display screen, the display device being a device as defined above.

According to other advantageous aspects of the invention, the display system comprises one or more of the following features, considered alone or according to all technically possible combinations:

the first interaction member includes a potentiometer comprising a finite number of possible positions.

the second interaction member includes a touch-sensitive surface.

The invention also relates to a method for displaying data on a display screen, the display method being implemented by a data display device able to be linked to a display screen, a first interaction member and a second interaction member, comprising the first steps:

obtaining a value of a setpoint among a first setpoint from the first interaction member and a second setpoint from the second interaction member, the value of the first setpoint being chosen from a first set of possible values and the value of the second setpoint being chosen from a second set of possible values, the second set of values including the first set of values;

generating display data as a function of a resultant setpoint value, the resultant setpoint value being the sum of an initial setpoint value and the obtained setpoint value;

the method further comprises a step for determining, after obtaining at least one value of the second setpoint, a recalibrated resultant setpoint value from the last used value of the resultant setpoint value, the recalibrated resultant setpoint value being a function of a value of the first set, the initial setpoint value used during the next display data generation being the recalibrated resultant setpoint value, the display parameter of the data being a zoom or a resolution with which the data can be displayed on the display screen.

The invention also relates to a non-transitory computer-readable medium including a computer program including software instructions which, when executed by a computer, implement a method as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of an aircraft equipped with an electronic data display system according to the invention, comprising a display screen, a first interaction member, a second interaction member and an electronic device for displaying information on the display screen;

FIG. 2 is a complementary schematic front view of the display system of FIG. 1; and

FIG. 3 is a flowchart of a data display method according to the invention carried out by the display device of FIG. 1.

### DETAILED DESCRIPTION

In the rest of the description, the expression “substantially equal to” defines a relationship of equality to within plus or minus 10%, preferably to within plus or minus 5%.

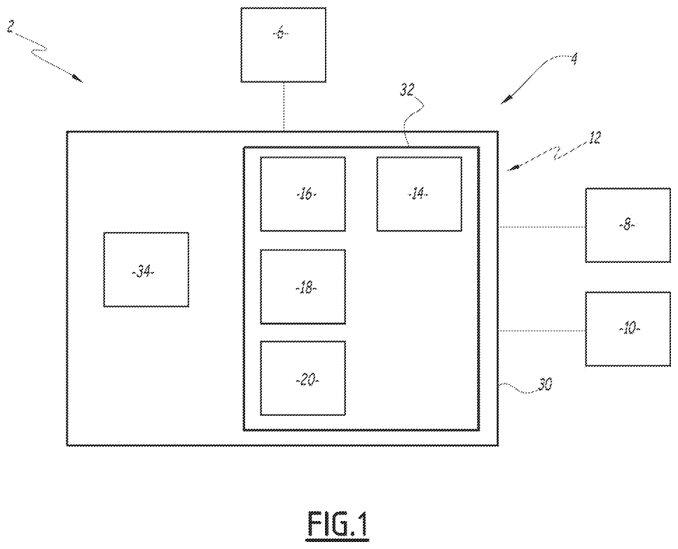

In FIG. 1, an aircraft 2 comprises an electronic data display system 4, including a display screen 6, a first interaction member 8, a second interaction member 10 and a device 12 for displaying data on the display screen 6.

The aircraft 2 is preferably an airplane. Alternatively, the aircraft 2 is a helicopter or a drone.

The display screen 6 is for example touch-sensitive. In a variant, the display screen 6 is not touch-sensitive, and the display system 4 then preferably further comprises a trackpad, not shown.

The first interaction member 8 is configured to select a first setpoint of a display parameter of the data, a value of said first setpoint being chosen from a first set A of possible values.

The display parameter of the data is for example the zoom with which the data are displayed on the display screen 6. In a variant, the display parameter of the data is the resolution of said data.

The first interaction member 8 is a man-machine interaction device used in an aircraft cockpit 2. The first interaction member 8 allows the designation by a user of a value among a given set of values. The designated value is the first data display parameter setpoint. The first interaction member 8 allows the designation of a value among the first set of values A.

The first interaction member 8 is for example a button including a finite number of possible positions. In particular, the first interaction member 8 is a potentiometer comprising a finite number of possible positions.

One skilled in the art will understand here that the finite number of possible positions of the first interaction member 8 corresponds to a discrete set of possible positions.

In particular, one skilled in the art will understand that the first set A is a discrete set, or a finite set, of possible values.

The second interaction member 10 is configured to select a second setpoint of the display parameter of the data, a value of said second setpoint being chosen from a second set B of possible values, the second set B of values including the first set A of values.

The second interaction member 10 is a man-machine interaction device used in an aircraft cockpit 2. The second interaction member 10 allows the designation of a value among a given set of values. The designated value is the second data display parameter setpoint. The second interaction member 10 allows the designation of a value among the second set B of values.

The second interaction member 10 is for example a touch-sensitive surface, in particular a capacitive touch-sensitive surface. The designated value for example corresponds to a value resulting from a tactile interaction. The designated value for example corresponds to the gap between the fingers of a user. As an example, the designated value is the difference in gap between the fingers of the user between the beginning of a tactile interaction, that is to say, when the user begins to touch the second interaction member 10, and the end of a tactile interaction, that is to say, when the user separates his fingers from the second interaction member 10.

The second interaction member 10 then has a set of positions tending toward infinity, the number of possible positions being limited by the resolution of the touch-sensitive surface. One skilled in the art will understand here that the number of possible positions of the second interaction member 10 is then comparable to a continuous set of possible positions. In particular, one skilled in the art will understand that the second set of values B is comparable to a continuous set of possible values.

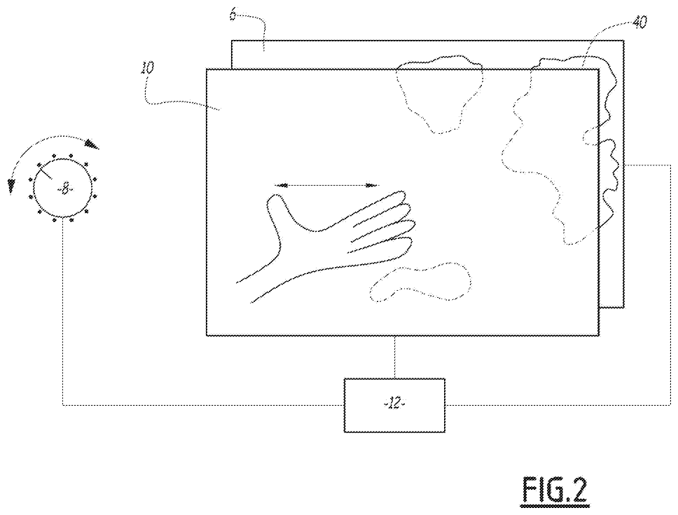

In the example of FIG. 2, the second interaction member 10 is a touch-sensitive surface placed on the display screen 6. The display screen 6 combined with the second interaction member 10 then forms a touch-sensitive screen. In a variant, the second interaction member 10 is a touch-sensitive surface separated from the display screen 6. Such a touch-sensitive surface is for example that of the trackpad.

The data display device 12 is linked to the display screen 6, the first interaction member 8 and the second interaction member 10.

In the example of FIG. 1, the display device 12 is embedded in the aircraft 2.

The data display device 12 comprises a module 14 for obtaining a value of a setpoint among the first setpoint from the first interaction member 8 and the second setpoint from the second interaction member 10; a module 16 for generating display data as a function of a resultant setpoint value; and a module 18 for determining a recalibrated resultant setpoint value after obtaining at least one value of the second setpoint.

The display device 10 comprises a module 20 for displaying, on the display screen 6, display data generated by the generating module 16.

In the example of FIG. 1, the display device 10 comprises an information processing unit 30, for example made up of a memory 32 associated with a processor 34.

In the example of FIG. 1, the obtaining module 14, the generating module 16, the determining module 18 and the display module 20 are each made in the form of software executable by the processor 34. The memory 32 is then able to store software for obtaining a value of a setpoint, software for determining a resultant setpoint value, software for generating display data, and software for displaying generated data. The processor 34 of the information processing unit 30 is then able to execute the obtaining software, the determining software, the generating software and the display software.

In a variant that is not shown, the obtaining module 14, the generating module 16, the determining module 18 and the display module 20 are each made in the form of a programmable logic component, such as an FPGA (Field Programmable Gate Array), or in the form of a dedicated integrated circuit, such as an ASIC (Applications Specific Integrated Circuit).

When the electronic display device 12 is made in the form of one or several software programs, i.e., in the form of a computer program, it is further able to be stored on a medium, not shown, readable by computer. The computer-readable medium is for example a medium suitable for storing electronic instructions and able to be linked with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

The obtaining module 14 is configured to obtain a value of a setpoint among the first setpoint from the first interaction member 8 and the second setpoint from the second interaction member 10.

In the example previously disclosed where the first interaction member 8 is a potentiometer and the second interaction member 10 is a touch-sensitive surface, the obtaining module 14 is configured to obtain a setpoint value among a first position value of the potentiometer, and among a tactile interaction value, for example a finger separation value. The obtained value is for example positive in the case of a separation of the fingers on the tactile surface and negative in the case of a pinching, in other words, a bringing together, of the fingers on the tactile surface.

The generating module 16 is configured to generate display data as a function of the resultant setpoint value. The resultant setpoint value is the sum of the initial setpoint value and the obtained setpoint value.

The initial setpoint value is for example a value recorded in the memory 32 of the display device when no interaction member has been used. The initial value then corresponds to a default value of the display parameter. The initial setpoint value is then updated following each generation of display data. The generation of display data follows the obtainment of a setpoint value, and the determination of a resultant setpoint value, recalibrated in the case of the obtainment of a second setpoint value. The first update of the initial value therefore takes place following a touch-sensitive interaction with the first interaction member or with the second interaction member.

The display data generated by the generating module 16 are for example the data of an aeronautical map 40. The resultant setpoint value then for example corresponds to a zoom value, in other words, a value of display dimensions of the map 40 on the screen 6. The display data generated by the generating module 16 then depend on the zoom value. One skilled in the art will understand here that the map 40 generated by the generating module will have a size depending on the zoom setpoint value. Thus, a low resultant setpoint value for example corresponds to a low zoom value and the map 40 will be displayed with a low magnification. Similarly, a high resultant setpoint value for example corresponds to a high zoom value and the map will be displayed with a high magnification.

The determining module 18 is configured in order, after obtaining at least one respective value of the second setpoint, to determine a recalibrated resultant setpoint value, from the last resultant setpoint value used. The recalibrated resultant setpoint value is also called repositioned resultant setpoint value, since it corresponds to a repositioning of the resultant setpoint value at a value able to be obtained via the first member 8.

The recalibrated resultant setpoint value is a function of a value of the first assembly. The recalibrated setpoint value is in particular used as initial setpoint value during the next generation of display data.

According to a first variant, the recalibrated resultant setpoint value is the sum of the initial setpoint value and the last value of the first set A corresponding to a value of the second setpoint. In other words, according to this first variant, the recalibrated resultant setpoint value is the sum of the initial value and the last value designated by the second interaction member 10 being able to be designated by the first interaction member 8.

According to the first variant and in the example where the display parameter is the data zoom displayed on the display screen 6, the zoom determined by the determining module 18 following the obtainment of at least one second setpoint value, that is to say, for example following a touch-sensitive interaction, corresponds to the last zoom done on the screen 6, which can be displayed via an interaction with the first interaction member 8.

According to a second variant, the recalibrated resultant setpoint value is the sum of the initial setpoint value and a first setpoint value that is closest to the last value designated by the second member 10. In other words, according to this second variant, the recalibrated resultant setpoint value is the sum of the initial value and the setpoint value able to be designated by the first interaction member 8 being the closest to the last value designated by the second interaction member 10.

According to the second variant and in the example where the parameter is the data zoom displayed on the display screen 6, the zoom determined by the determining module 18 following the obtainment of at least one second setpoint value, that is to say, for example following a touch-sensitive interaction, corresponds to the zoom able to be displayed on the screen 6 via an interaction with the first interaction member 8, which is the closest to the zoom designated by the second interaction member 10.

According to a third embodiment variant, the recalibrated resultant setpoint value is the sum of the initial setpoint value and the last first setpoint value. In other words, according to this third variant, the recalibrated resultant setpoint value is the sum of the initial value and the value designated by the first interaction member 8, irrespective of the second setpoint value designated via the second interaction member 10.

According to this third variant and in the example where the display parameter is the data zoom displayed on the display screen 6, the zoom determined by the determining module 18 following the obtainment of at least one second setpoint value, that is to say, for example following a touch-sensitive interaction, corresponds to the zoom designated via the first interaction member 8.

The determining module 18 is further configured in order, after obtaining only first setpoint value(s), to determine the sum of the last used first setpoint value and the initial setpoint value as initial setpoint value during the next display data generation. In other words, following the interaction with the first interaction member 8 only, the initial value used during the next data generation is determined as the sum of the current initial value and the value designated by the first interaction member 8.

In the example where the display parameter is the data zoom displayed on the display screen 6, the zoom determined by the determining module corresponds to the zoom designated by the first interaction member.

Following the determination by the determining module 18 of the resultant setpoint value, and if applicable, recalibrated resultant setpoint value, the initial setpoint value is updated, and display data are generated by the generating module 16.

The generation of display data by the generating module 16 is preceded by obtaining a respective setpoint value by the obtaining module 14, and determining a resultant setpoint value and if applicable the recalibrated resultant setpoint value. Thus, in the case where the second interaction member 10 is a touch-sensitive surface, the generation of display data takes place at the end of the touch-sensitive interaction, in particular at the end of a sliding movement, such as the separation or pinching of fingers. All throughout the tactile interaction, the data displayed on the screen 6 are for example able to be modified without the generating module 16 generating display data. In particular, the display data displayed on the screen 6 are able to be interpolated so as to simulate a modification of the display parameter on the screen 6 during the interaction. At the end of the interaction, the generating module 16 then generates new display data and defines the value of the display parameter.

In the case where the display parameter is the zoom, this then leads to a so-called elastic zoom effect. During a respective interaction with the second interaction member 10, the user will be able to modify the zoom level displayed on the screen 6 without the generating module 16 generating display data. Upon the release of the second interaction member 10, the generating module 16 generates new display data and the zoom is updated. The zoom then corresponds to a zoom able to be designated by the first interaction member 8.

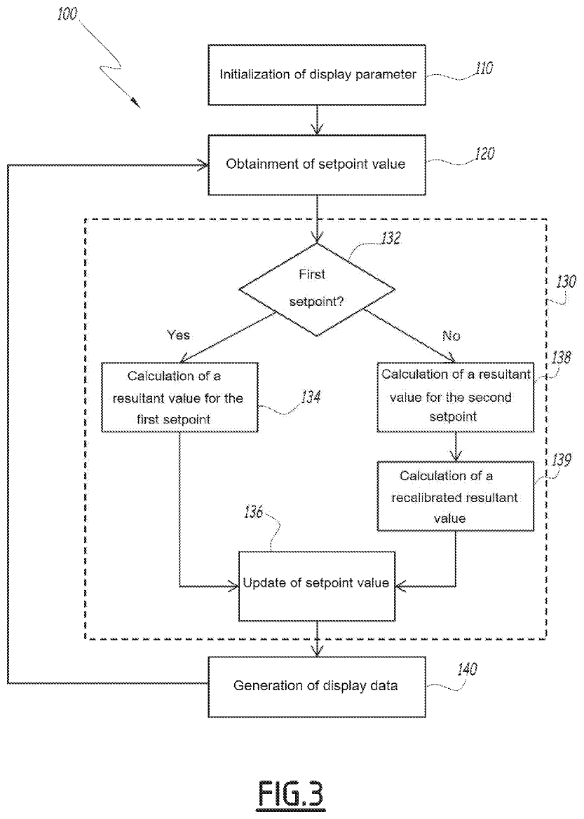

In FIG. 3, the display method 100 begins with an initialization step 110 during which an initial value is assigned to the data display parameter. The assigned initial value is for example a default value stored in the memory 32.

After the initialization step 110, the obtaining module 14 obtains, during an obtaining step 120, a value of a setpoint among a first setpoint from the first interaction member 8 and a second setpoint from the second interaction member 10, the value of the first setpoint being chosen from the first set A of possible values and the value of the second setpoint being chosen from the second set B. This step is for example carried out when the user interacts with the first interaction member 8 or the second interaction member 10.

Following the obtaining step 120, the determining module 18 determines, during a determining step 130, a resultant value or a recalibrated resultant value. The determining step 130 is different if the obtained setpoint value is a first setpoint value or a second setpoint value.

The determining step 130 includes a first setpoint test sub-step 132, during which the determining module 18 determines whether the obtained setpoint is a first setpoint value.

If the test performed during the sub-step 132 is positive, that is to say, if the obtained setpoint value is a first setpoint value, then the determining module 18 calculates a resultant value for the first setpoint during a sub-step 134 for calculating a resultant value for the first setpoint.

During the sub-step 134 for calculating a resultant value for the first setpoint, the determining module 18 calculates the resultant value as the sum of the preceding initial value and the obtained first setpoint value. The determining module 18 next associates the resultant value with the initial value during a setpoint value update sub-step 136.

If the test performed during the sub-step 132 is negative, that is to say, if the obtained setpoint value is a second setpoint value, then the determining module 18 calculates a resultant value for the second setpoint during a sub-step 138 for calculating a resultant value for the second setpoint.

During the sub-step 138 for calculating a resultant value for the second setpoint, the determining module 18 calculates the resultant value as the sum of the preceding initial value and the obtained second setpoint value.

After the sub-step 138 for calculating a resultant value for the second setpoint, the determining module 18 calculates the recalibrated resultant value during a sub-step 139 for calculating the recalibrated resultant setpoint value. The determining module 18 calculates the recalibrated resultant setpoint value from the resultant value and as a function of the first set A. The recalibrated resultant setpoint value is for example calculated as the sum of the initial setpoint value and the last value of the first set corresponding to a value of the second setpoint.

The recalibrated resultant setpoint value is, according to a first variant, the sum of the initial setpoint value and a first setpoint value that is closest to the last used value of the resultant setpoint value.

The recalibrated resultant setpoint value is, according to a second variant, the sum of the initial setpoint value and the last first setpoint value.

Following the sub-step 139, the determining module 18 associates the recalibrated resultant value with the initial value during the setpoint value update sub-step 136.

During the sub-step 136 for updating the setpoint value, the determining module 18 replaces the initial setpoint value with the resultant value obtained after obtaining a first setpoint value and with the resultant value recalibrated after obtaining a second setpoint value.

The determining step 130 then includes the sub-steps 132 to 139 previously disclosed.

Following the determining step 130, the generating module 16 generates display data during a generating step 140.

During the generating step 140, display data are generated as a function of the resultant setpoint value, said resultant setpoint value having been recalibrated in the case of the obtainment of a second setpoint.

One can thus see that the data display device 12 and the display method 100 according to the invention make it possible to improve the interaction with the user during the display of the data.

The data display device 12 and the display system 4 according to the invention in particular make it possible to ensure the coherence of the signals coming from a first interaction member 8 and a second interaction member 10. Indeed, following one or several interactions with the first 8 and/or second 10 interaction member, and when said interactions are complete, the generating module 16 generates new display data as a function of a setpoint value shared by the first 8 and second 10 interaction members.

1. A device for displaying data on a display screen, the display device being able to be connected to:
a first interaction member configured to select a first setpoint of a display parameter of the data, a value of said first setpoint being chosen from a first set of possible values;
a second interaction member configured to select a second setpoint of said parameter, a value of said second setpoint being chosen from a second set of possible values, the second set of values including the first set of values; and
the display screen;
the display device comprising:
an obtaining module configured to obtain a value of a setpoint among the first setpoint from the first interaction member and the second setpoint from the second interaction member, and
a generating module configured to generate display data as a function of a resultant setpoint value, the resultant setpoint value being the sum of an initial setpoint value and the obtained setpoint value;
wherein the display device further comprises a determining module configured, after obtaining at least one value of the second setpoint, to determine a resultant setpoint value recalibrated from the last resultant setpoint value used, the recalibrated resultant setpoint value being a function of a value of the first set, the initial setpoint value used during the next display data generation being the recalibrated resultant setpoint value,
and wherein the display parameter of the data being a zoom or a resolution with which the data can be displayed on the display screen.

2. The data display device according to claim 1, wherein the recalibrated resultant setpoint value is the sum of the initial setpoint value and the last value of the first set corresponding to a value of the second setpoint.

3. The data display device according to claim 1, wherein the recalibrated resultant setpoint value is the sum of the initial setpoint value and a first setpoint value that is closest to the last used value of the resultant setpoint value.

4. The data display device according to claim 1, wherein the determining module is configured in order, after obtaining only first setpoint value(s), to determine the sum of the last used first setpoint value and the initial setpoint value as initial setpoint value during the next display data generation.

5. The data display device according to claim 1, wherein the device further comprises a display module configured to display, on the display screen, the generated display data.

6. An electronic system for displaying data, the display system comprising:
a display screen;
a first interaction member;
a second interaction member; and
an electronic device for displaying information on the display screen, the display device being linked to the screen, the first interaction member and the second interaction member,
wherein the display device is according to claim 1.

7. The system according to claim 6, wherein the system is intended to be embedded in an aircraft.

8. The system according to claim 6, wherein the first interaction member includes a potentiometer comprising a finite number of possible positions.

9. The system according to claim 6, wherein the second interaction member includes a touch-sensitive surface.

10. A method for displaying data on a display screen, the display method being implemented by a data display device able to be linked to a display screen, a first interaction member and a second interaction member and comprising the first steps:
obtaining a value of a setpoint among a first setpoint from the first interaction member and a second setpoint from the second interaction member, the value of the first setpoint being chosen from a first set of possible values and the value of the second setpoint being chosen from a second set of possible values, the second set of values including the first set of values;
generating display data as a function of a resultant setpoint value, the resultant setpoint value being the sum of an initial setpoint value and the obtained setpoint value;
wherein the method further comprises a step for determining, after obtaining at least one value of the second setpoint, a recalibrated resultant setpoint value from the last used value of the resultant setpoint value, the recalibrated resultant setpoint value being a function of a value of the first set, the initial setpoint value used during the next display data generation being the recalibrated resultant setpoint value,
and wherein the display parameter of the data being a zoom or a resolution with which the data can be displayed on the display screen.

11. A non-transitory computer-readable medium including a computer program comprising software instructions which, when executed by a computer, carry out a method according to claim 10.
